(19) United States
(12) Patent Application Publication
(10) Pub. No.: US 2025/0335061 A1
(43) Pub. Date: Oct. 30, 2025

(54) METAL MESH TOUCH DISPLAY DEVICE

(71) Applicant: TPK Advanced Solutions Inc., Xiamen (CN)

(72) Inventors: Ting Chieh Chien, Taipei City (TW); Ching Kai Cho, Taipei City (TW); Wei Jie Lin, Xiamen City (CN); Chien Lin Cheng, Taipei City (TW)

(21) Appl. No.: 19/071,835

(22) Filed: Mar. 6, 2025

(30) Foreign Application Priority Data
Apr. 24, 2024 (CN) 202410497039.2
Apr. 29, 2024 (TW) 113115940

(51) Int. Cl. G06F 3/044

(52) U.S. Cl. CPC G06F 3/0446; G06F 2203/04112

(57) ABSTRACT

The present disclosure provides a metal mesh touch display device, including a metal mesh touch unit, having a metal line width greater than 2.5 μm and/or an area of a mesh node greater than 80 μm²; a display unit, having a plurality of light emitting pixels wherein the light emitting pixel density of the display unit is greater than 150 ppi; and a microstructure layer located between the display unit and the metal mesh touch unit and having a substrate layer and a microstructure, wherein the distance between the surface of the display unit and the metal mesh touch unit is greater than 0.2 mm.

### CROSS-REFERENCE TO RELATED APPLICATION

The instant application claims priority to China Patent Application 202410497039.2, filed on Apr. 24, 2024, which is incorporated herein by reference.

### BACKGROUND

### Field of Disclosure

The present disclosure relates to a metal mesh touch display device, more specifically, a display device having astigmatic microstructures or light-diverging microstructures, disposed between the display unit and the metal mesh touch unit.

### Description of Related Art

Recently, touch display devices have become the main stream of the display market. The metal mesh technology available nowadays uses fine lines made of silver or copper of high electric conductivity to produce metal meshes to serve as touch electrodes. These touch electrodes have excellent electric conductivity and therefore create unique advantages while being implemented in middle- and large-size touch display devices. For example, high-end laptop computers usually have pen-writing functions while the metal meshes of high electric conductivity can meet the requirement of low latency specification.

However, due to the opacity of the metal fine lines, optical interference may appear and result in poor visual effect if the light emitting unit (pixel specification, such as dimensions, arrangements . . . ) and the metal meshes in the design of display device are not properly set up. For example, when the size of the metal fine line does not appropriately match the dimensions of the light emitting pixel area of the display device, the metal mesh may block a part of the light emitting pixel area and create a shadow. As a result, the user may see a gray grid phenomenon.

To resolve the cause of the gray grid problem, the prior art increases the pixel area or changes the design of the metal mesh (for example, the size or pattern).

However, the task of these manufacturers who assemble touch modules is to assemble the display units, for example organic light emitting diode (OLED) or liquid crystal display (LCD), together with the touch modules provided by the upstream suppliers. The specifications of the display units provided by the upstream suppliers are basically fixed, which cannot be changed arbitrarily. Therefore, the method that increases the pixel area to resolve the gray grid problem is not applicable to these manufacturers who assemble touch modules. Furthermore, the act of increasing the pixel area reduces the resolution density (also known as, pixel density or pixels per inch (ppi)) of the display devices correspondingly, which will not meet the market demand for high resolution display devices.

On the other hand, in consideration of the commercial mass production, the technology of manufacturing metal meshes used by touch module factories is a process of relatively low cost and high yield rate that cannot be replaced by other uncertified manufacturing processes (for example, small scale testing process in the laboratory) of metal meshes. For example, Patent CN105892737 discloses a method for resolving problems due to Moiré effect by applying a unique included angle of the metal mesh to be aligned with the pixels of the display device. Nevertheless, metal lines of such a special design may not be suitable for mass production. Another method is to reduce the width of the metal line so that it can reduce the probability that the pixel light will be blocked by the metal lines. However, the act of reducing the width of the metal line will increase the electrical impedance thereof and then reduce touch sensitivity. Therefore, the method of adjusting the size of the metal mesh to resolve the gray grid problem is not workable.

In view of the aforementioned disadvantages, the present disclosure is developed and provides a better and workable solution.

### SUMMARY

In view of the aforementioned technical bottleneck, the objective of the present disclosure is to provide a metal mesh touch display device that can resolve the gray grid problem without changing the pixel configuration of the display unit and the dimensions of the metal mesh.

In one embodiment, the present disclosure provides a metal mesh touch display device, comprising a metal mesh touch unit, having at least one of a metal line width greater than 2.5 μm or a mesh node having an area of a mesh node that is greater than 80 μm²; a display unit, having a plurality of light emitting pixels wherein a light emitting pixel density of the display unit is greater than 150 ppi; and a microstructure layer located between the display unit and the metal mesh touch unit with a substrate layer and a microstructure, wherein a distance between a surface of the display unit and the metal mesh touch unit is greater than 0.2 mm.

In one embodiment of the present disclosure, at least one surface of the microstructure is composed of a plurality of convex parts, a plurality of concave parts, or a combination thereof to form an astigmatic structure; or the microstructure is composed of a plurality of convex parts, a plurality of concave parts, or a combination thereof to form an astigmatic structure.

In one embodiment of the present disclosure, at least one of the metal line width is greater than 3.5 μm or the area of the mesh node is greater than 100 μm².

In one embodiment of the present disclosure, at least one of the metal line width is between 3.5-5 μm or the area of the mesh node is greater than 80-200 μm².

In one embodiment of the present disclosure, the distance between the surface of the display unit and the metal mesh touch unit is between 0.2-1.0 mm.

In one embodiment of the present disclosure, the light emitting pixel density of the display unit is 150-400 ppi.

In one embodiment of the present disclosure, the microstructure layer further comprises an upper adhesive layer and a lower adhesive layer, the upper adhesive layer is disposed below the metal mesh touch unit; the substrate layer is disposed on a lower surface of the upper adhesive layer and has a flat shape; the microstructure is disposed on a lower surface of the substrate layer and a lower surface of the microstructure has a plurality of convex parts, a plurality of concave parts, or a combination thereof to form an astigmatic structure; and the lower adhesive layer is disposed between the lower surface of the microstructure and the display unit, wherein an upper surface of the lower adhesive layer has a shape that matches and fits to the lower surface of the microstructure.

In one embodiment of the present disclosure, a distance between neighboring convex parts of the plurality of convex pars is 0.1-50 μm.

In one embodiment of the present disclosure, a distance between neighboring convex parts of the plurality of convex pars is 6-10 μm.

In one embodiment of the present disclosure, a ratio of depth to width of the microstructure is about 0.1-1.5.

In one embodiment of the present disclosure, a ratio of depth to width of the microstructure is about 0.1-0.3.

In one embodiment of the present disclosure, the microstructure is disposed on a lower surface of the substrate layer, an upper surface of the microstructure is composed of a plurality of convex parts, a plurality of concave parts, or a combination thereof to form an astigmatic structure; and the lower surface of the substrate layer has a shape that matches and fits to the upper surface of the microstructure.

In one embodiment of the present disclosure, a distance between neighboring convex parts of the plurality of convex parts is 0.1-50 μm.

In one embodiment of the present disclosure, a distance between neighboring convex parts of the plurality of convex parts is 10-20 μm.

In one embodiment of the present disclosure, a ratio of depth to width of the microstructure is about 0.1-1.5.

In one embodiment of the present disclosure, a ratio of depth to width of the microstructure is about 0.5-0.1.

In one embodiment of the present disclosure, the microstructure layer further comprises a lower adhesive layer and an upper adhesive layer, the lower adhesive layer is disposed on the display unit; the substrate layer is disposed on an upper surface of the lower adhesive layer and has a flat shape; the microstructure is disposed on an upper surface of the substrate layer and is composed of a plurality of convex parts. Furthermore, the upper adhesive layer is disposed between both an upper surface of the microstructure and the upper surface of the substrate layer, and the metal mesh touch unit; a lower surface of the upper adhesive layer has a shape that matches and closely to both the upper surface of the microstructure and the upper surface of the substrate layer.

In one embodiment of the present disclosure, a distance between neighboring convex parts of the plurality of convex parts is 0.1-50 μm.

In one embodiment of the present disclosure, a distance between neighboring convex parts of the plurality of convex parts is 20-30 μm.

In one embodiment of the present disclosure, a ratio of depth to width of the microstructure is about 0.1-1.5.

In one embodiment of the present disclosure, a ratio of depth to width of the microstructure is about 0.2-0.3.

In one embodiment of the present disclosure, the metal mesh touch unit comprises a first metal mesh electrode, oriented along a first direction; a second metal mesh electrode, oriented along a second direction; and a base layer, located between the first metal mesh electrode and the second metal mesh electrode.

In one embodiment, the present disclosure provides a metal mesh touch display device comprising a metal mesh touch unit, having at least one of a metal line width greater than 2.5 μm or a mesh node having an area that is greater than 80 μm²; a display unit, having a plurality of light emitting pixels wherein an area of a smallest light emitting pixel of the plurality of light emitting pixels of the display unit is 400-900 μm²; and a microstructure layer located between the display unit and the metal mesh touch unit and having a substrate layer and a microstructure, wherein a distance between a surface of the display unit and the metal mesh touch unit is greater than 0.2 mm.

In one embodiment of the present disclosure, the microstructure has a plurality of convex parts, a plurality of concave parts, or a combination thereof to form an astigmatic structure.

In one embodiment of the present disclosure, a distance between neighboring convex parts of the plurality of convex parts is 0.1-50 μm.

In one embodiment of the present disclosure, a ratio of depth to width of the microstructure is about 0.1-1.5.

In summary, the metal mesh touch display device of the present disclosure can resolve the gray grid problem by means of disposing an astigmatic microstructure between the display unit and the metal mesh touch unit and properly adjusting the distance between the display unit and the metal mesh touch unit, without changing the configuration of the display unit provided by the upstream suppliers nor the dimensions of the metal mesh.

Overall, the metal mesh touch display device of the present disclosure can meet the requirements of high resolution display (without increasing the light emitting pixel area), high touch sensitivity (without reducing the dimensions of the metal lines) and, at the same time, resolve the gray grid problem by means of disposing an astigmatic microstructure between the display unit and the metal mesh touch unit and properly adjusting the distance between the display unit and the metal mesh touch unit.

### BRIEF DESCRIPTION OF THE DRAWINGS

To better understand the aforementioned objective and other objectives, novel features, advantages, embodiments, and the effect of the present disclosure, relevant diagrams are provided as follows.

FIG. 1 is a schematic diagram of the astigmatism effect of the microstructure of the present disclosure;

FIG. 2 is a stack up diagram of the metal mesh touch display device of the first embodiment of the present disclosure;

FIG. 3 is a schematic diagram of the metal mesh touch unit of the present disclosure;

FIG. 3A is a partial enlarged view of region a of FIG. 3;

FIG. 4 is a stack up diagram of the metal mesh touch display device of a second embodiment of the present disclosure;

FIG. 5 is a stack up diagram of the metal mesh touch display device of a third embodiment of the present disclosure;

FIG. 6 is a stack up diagram of the metal mesh touch display device of a fourth embodiment of the present disclosure; and

FIG. 7 is a stack up diagram of the metal mesh touch display device of a fifth embodiment of the present disclosure.

### DETAILED DESCRIPTION

A plurality of embodiments of the present disclosure will be disclosed below with reference to drawings, so that the advantage, characteristics, and achievable methods of the present disclosure are apparent. However, these detailed descriptions of the embodiments in practice are for illustration only and shall not be interpreted to limit the scope, applicability, or configuration of the present disclosure in any way. That is, in some embodiments of the present disclosure, these details in practice are not required.

The terminology in the present disclosure is for describing specific embodiments only and shall not be interpreted to limit the scope. Unless otherwise explicitly specified in the descriptions, the singular forms of “a” and “the” used in the present disclosure can also refer to plural forms.

Furthermore, the spatial terminology of the present disclosure, for example, “below”, “under”, “beneath”, “lower”, “above”, “over”, “higher”, “left side”, “right side”, “side”, is used for the relative spatial positions in the figures and describes the relative position of one component with respect to another component or a plurality of components in the figure. In addition to the orientation described in the figures, the spatial terminology of the present disclosure can mean different orientations. For example, if the equipment/device/component in the figure is rotated, then a component described as “below” other components or the featured component will become in a position of “above” other components or the featured component accordingly. Therefore, the term “below” in the description can refer to two orientations of above and below, or other orientation corresponding to the relative spatial relations among equipment/devices/components.

Unless explicitly specified in the description, the value in the description is not an exact value and can be viewed as an approximation, that is, the expression of “about”, “nearly”, or “approximate” indicating a value with deviation or a range. The values, which may include manufacturing tolerance and measurement error, become more fully understood to those skilled in the art. The margins of tolerance or error range from positive 20% to negative 20%, or positive 10% to negative 10%, or positive 5% to negative 5%.

Please note that although certain vocabularies such as “first” and “second” are used in the text to represent various components, these described components shall not be limited by and rely on the naming method and wording. These terms are used for distinguishing different components. Therefore, a “first” component described in one embodiment can be expressed as a “second” component in another embodiment without departing from the scope of the present disclosure. In the present disclosure, same component symbols represent identical or similar components.

Without causing any contradiction, the technical characteristics, including thickness, shape, materials, refractive index, and more described in any one embodiment of the present disclosure, are applicable to other embodiments of the present disclosure.

Please refer to FIG. 2. The first embodiment of the present disclosure provides a metal mesh touch display device 1, comprising a metal mesh touch unit 50, having a metal line width greater than 2.5 μm and/or an area of a mesh node greater than 80 μm²; a display unit 10, having a plurality of light emitting pixels wherein the light emitting pixel density of the display unit 10 is greater than 150 ppi; and a microstructure layer 31 located between the display unit 10 and the metal mesh touch unit 50 having a substrate layer 31b and a microstructure 31c, wherein the microstructure layer 31 can define a distance between the display unit 10 and the metal mesh touch unit 50 (for example, a distance greater than 0.2 mm) to reduce the blocking area on the display unit 10 by the metal mesh touch unit 50, so that users will not sense the visual impact of the metal mesh touch unit 50.

Preferably, the metal line width of the metal mesh touch unit 50 is greater than 2.5 μm and the area of a mesh node is greater than 80 μm².

In one preferable embodiment, the metal line width of the metal mesh touch unit 50 is greater than 3.5 μm and less than 5 μm; or the area of a mesh node of the metal mesh touch unit 50 is greater than 100 μm² and less than 200 μm²; or the metal mesh touch unit 50 has both of the aforementioned two features, i.e., line width and area of a mesh node.

In the present disclosure, the display unit 10 can be an organic light emitting diode (OLED) unit, a liquid crystal display (LCD) unit, or other types of display units. The metal mesh touch unit 50 can be, but is not limited to, a metal mesh made of copper (Cu) or silver (Ag).

The present disclosure is specifically for the display unit 10 for high-resolution applications since the area of the sub-pixel thereof is small and may be blocked easily by the metal lines. More specifically, the display unit 10 is considered to be high-resolution when the display unit 10 has a pixel density of 150-1000 ppi, or 150-800 ppi, or 150-400 ppi, or 150-300 ppi. In the first embodiment of the present disclosure, the display unit 10 is an OLED display of 14 inches with a resolution of 1920×1200 and a pixel density of 162 ppi by calculation. The OLED display of the embodiment has three different colors, red (R), green (G), and blue (B) sub-pixels arranged side-by-side. Every R, G, and B sub-pixel emits dimmable light individually and independently, and creates color light after mixing with different gray-scales and different chromatic color light.

In one embodiment, the display unit 10 is an OLED display of 15 inches with a resolution of 1920×1200 and a pixel density of 151 ppi. In another embodiment, the display unit 10 is an OLED display of 13 inches with a resolution of 1920×1200 and a pixel density of 174 ppi. In another embodiment, the display unit 10 is an LCD display of 13 inches with a resolution of 2560×1600 and a pixel density of 232 ppi. The pixel density in this specification is calculated using a pixel density calculator available on the internet, such as, but not limited to, https://ppi.0123456789.tw/.

It is worth mentioning that the present disclosure solves the problem that light emitted by the display unit 10 is blocked by the metal lines. In addition, R, G, and B sub-pixels or other color sub-pixels (for example white color) of the OLED display unit belong to active light emitting technology. Therefore, the present disclosure can be applied to OLED-based products. On the other hand, RGB light of the LCD is produced by the light (passive light emitting) emitted from the backlight module and passing through a color filter. The present disclosure also can use the microstructure layer 31 to solve the problem that the backlight of LCD is blocked by metal lines. In other words, regardless of what forms of light emitting the metal mesh touch display device 1 use, the present disclosure can improve or eliminate gray grid problems by means of the microstructure layer 31 without changing the display unit 10 nor the metal mesh touch unit 50. The present disclosure can also resolve the visual impact caused by the metal mesh touch display device 1 when having a high-resolution (such as pixel density greater than 150 ppi) in coordination with metal mesh fine lines of specific configurations (such as mesh width greater than 2.5 μm, area of a mesh node greater than 80 μm²).

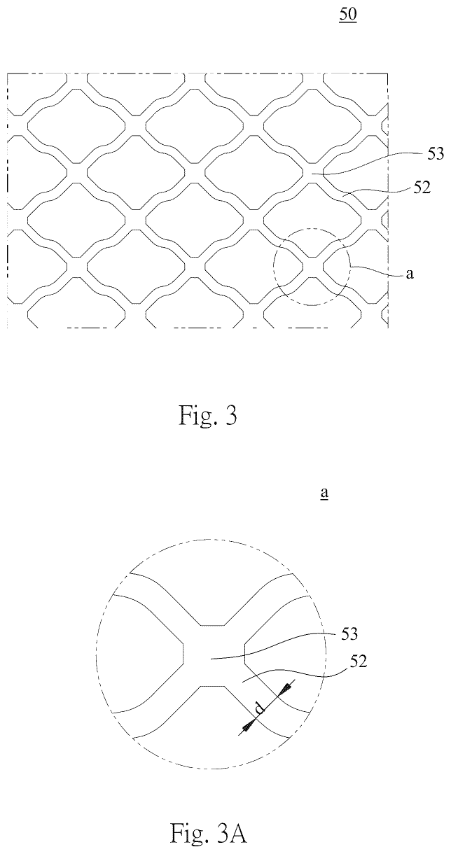

Please refer to FIG. 3 and FIG. 3A. The metal mesh touch unit 50 mainly comprises a plurality of metal lines 52 (or also known as metal fine lines or mesh lines) that are connected together. This type of technology is called metal mesh (MM) in this field. Such technology can be featured by the metal line width or the area of node. The metal line width or the area of mesh node can be designed independently and are not specifically correlated. Intersections of metal lines 52 form mesh nodes 53. The smallest line width (hereinafter referred to as “d”) is 1.5-5.0 μm (for example, 2 μm); or 2.5-4.5 μm, or 3.0-3.5 μm. The area of each of the mesh nodes 53 is 40-200 μm² (such as 80 μm² or 100 μm²), 50-100 μm², or 60-80 μm². The metal mesh touch unit 50 of the first embodiment of the present disclosure uses copper fine lines of three specifications having line width d of 3.5, 4, 4.5 μm. The areas of the mesh nodes 53 of the copper lines of three different line widths are all 100 μm². According to the embodiments below (please refer to Table 1), the present disclosure can improve the gray grid effect and prevent the poor visual effect.

In the metal mesh touch display device 1 of the present disclosure, the microstructure layer 31 is disposed between the display unit 10 and the metal mesh touch unit 50. The thickness of the microstructure layer 31 is adjusted so that the distance between the display unit 10 and the metal mesh touch unit 50 is the smallest. For example, the distance between the first surface (that is, the upper surface 10A of the display unit 10 shown in FIG. 2) of the display unit 10 facing the metal mesh touch unit 50 and the second surface (that is, the lower surface 51 of the metal mesh touch unit 50 shown in FIG. 2) of the metal mesh touch unit 50 is greater or equal to 0.2 mm, so that the distance between the light source (display unit 10) and the shading object (metal mesh touch unit 50) is properly widened. Therefore, the shaded area (for viewers from a distance) of shading object on the light source can be reduced and, as a result, the gray grid level can be reduced. On the other hand, the method can be explained by the correlations among the light source, object, and shadow. According to the theory of linear propagation of light, when light cannot penetrate an obstacle, a shadow will appear behind the object. By the same token, when the R or G or B sub-pixel (that is, light source) of the present disclosure emits light, blockage is formed in front of the metal line 52 (that is, obstacle) and becomes a shadow visible to viewers as the aforementioned gray grid. Based on, but not limited to, this theory, when the obstacle and the light source get closer, the shadow becomes larger and the shadow (that is, gray grid) can be seen more easily by viewers. In the present disclosure, the size of the shadow becomes smaller by means of increasing the distance between the obstacle and the light source, so that the visible shadow observed by viewers can be reduced.

Nevertheless, in order to keep the display devices small and slim, the distance between the upper surface 10A of the display unit 10 and the lower surface 51 of the metal mesh touch unit 50 shall not be too large. For example, the aforementioned distance is preferably less than 1 mm or less than 0.6 mm.

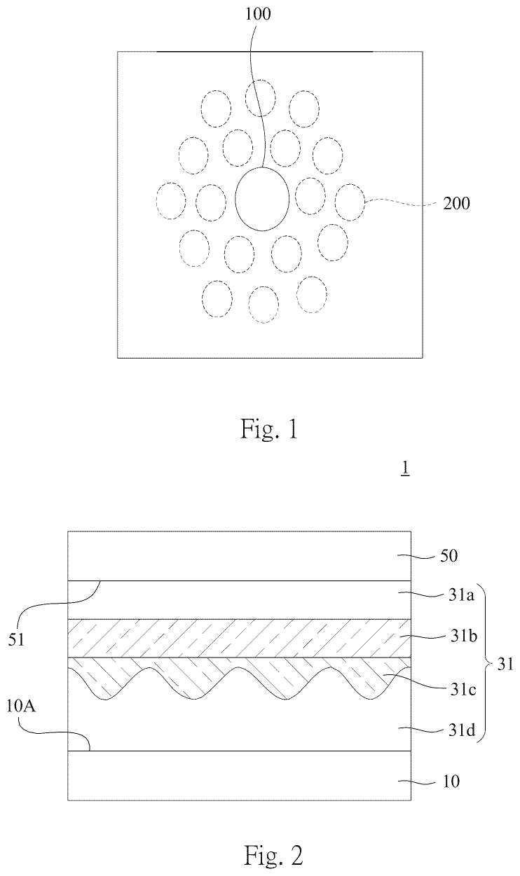

Moreover, in the present disclosure, the microstructure 31c has an uneven surface in order to provide the astigmatism effect and/or the light-diverging effect, so that a single light emitting spot 100 is properly expanded to be multiple diverse secondary light spots 200 (as shown in FIG. 1). The single light emitting spot 100 can be treated as the main light spot and is expanded into a plurality of diverse secondary light sources (that is, secondary light spots 200) by the microstructure 31c, in order to reduce the ratio or probability that the light source (that is, the single light emitting spot 100) is blocked by the metal lines 52. As a result, the gray grid problem resulting from the aforementioned light blocked by the metal lines 52 maybe reduced. In other words, for the RGB sub-pixels of the first embodiment, the light emitted from every sub-pixel is scattered or diverged by the microstructure 31c into multiple light spots. FIG. 2 illustrates the effect after the scattering. Due to the aforementioned scattering effect, the probability that the light emitted by every sub-pixel is blocked by the metal mesh touch unit 50 is reduced.

For example, at least one surface of the microstructure 31c has a plurality of convex parts, a plurality of concave parts, or a combination thereof to form an astigmatic/light-diverged structure; or the microstructure 31c has a plurality of convex parts, a plurality of concave parts, or a combination thereof to form an astigmatic/light-diverged structure. Therefore, the microstructure 31c can provide an effect similar to convex lenses or concave lenses. For every single light emitting object, the light source spot then will scatter and expand into multiple light sources, to reduce the probability of being blocked and to lessen the brightness difference between the shaded area and the non-shaded area. Therefore, the microstructure of the present disclosure is also called an “astigmatic/light-diverged microstructure”. In summary, the present disclosure coordinates and combines two different effects of “diversifying light source” and “bringing the obstacle (that is, metal lines) and the light source (that is, light emitted from the metal mesh touch display device 1) apart from each other by a predetermined distance”, in order to solve the visual effect problem caused by the metal lines 52 that blocks the light source. In one comparative embodiment, although the distance between the upper surface 10A of the display unit 10 and the lower surface 51 of the metal mesh touch unit 50 is set as 0.18 mm, users can still notice the aforementioned gray grid problem.

Furthermore, the microstructure layer 31 of the present disclosure can further comprise an adhesive layer, for example, disposed on the top and/or the bottom layer of the microstructure layer 31.

Please refer to FIG. 2 again. In the first embodiment of the present disclosure, the microstructure layer 31 further comprises an upper adhesive layer 31a and a lower adhesive layer 31d to make the microstructure layer 31 tightly adhered to other components and assemblies.

More specifically, in the first embodiment of the present disclosure, the upper adhesive layer 31a is disposed below the metal mesh touch unit 50. The substrate layer 31b is disposed on the lower surface of the upper adhesive layer 31a and has a flat shape. The microstructure 31c is disposed on the lower surface of the substrate layer 31b and the upper surface of the microstructure 31c has a flat shape, whereas the lower surface of the microstructure 31c has a wave form which is a combination of a plurality of convex parts and a plurality of concave parts. In addition, the lower adhesive layer 31d is disposed between the lower surface of the microstructure 31c and the display unit 10; the upper surface of the lower adhesive layer 31d has a shape that matches and closely fits to the lower surface of the microstructure 31c. The lower adhesive layer 31d can adhere the display unit 10.

Although only one surface of the microstructure 31c in the first embodiment has an un-even shape, the present disclosure is not limited to that illustrated in FIG. 2. The microstructures in any embodiment can be defined as both upper and lower surfaces having an un-even shape, such as convex parts, concave parts, or wave form (as described, preferably a sine wave form), so long as the shape can scatter a main light or diverge a main light to create multiple secondary lights. In the embodiment of the present disclosure, the microstructure 31c of the microstructure layer 31 can adjust the light of a single light source into a plurality of secondary light spots 200 of less brightness spread around the main light spot as illustrated in FIG. 1. The locations of the secondary light spots 200 will not overlap with that of the main light spot, and the lightness or energy of each of the secondary light spots is less than that of the main single light. There are two effects: 1. the distance between the metal lines 52 and the light source (that is, light emitting pixel) becomes further apart, 2. the metal lines 52/mesh nodes 53 form smaller shaded areas (under the assumption that viewers are located at a position of relatively infinite distance). Under the effect of the aforementioned two mechanisms: astigmatic mechanism (lowering the probability of light source being blocked) and reducing shaded area mechanism (reducing the shaded areas), the gray grid problem caused by the metal lines 52 blocking the light of metal mesh touch display device 1 can be improved or eliminated.

Under the condition that the upper and lower surfaces of the microstructure 31c have non-even surfaces, it is applicable to set a layer on the upper and lower surfaces of the microstructure 31c separately having a surface shape that matches and closely fits to the corresponding surface of the microstructure 31c, for instance, the adhesive layer or substrate layer 31b.

In the present disclosure, the substrate layer 31b provided on the side of the flat surface of the microstructure 31c and the adhesive layer having a surface shape that matches the un-even surface of the microstructure 31c can support and protect the microstructure 31c.

In the present disclosure, in order to maintain the transmittance of the metal mesh touch display device 1 except the metal mesh touch unit 50, layers on the outer side of the display unit 10 (the side facing the users) preferably are made of transparent materials.

For example, the substrate layer 31b can be made of transparent materials, including plastic, glass, glass ceramics, or quartz (SiO₂). Transparent plastic materials are, but are not limited to, polymethylmethacrylate, polyethylene terephthaclate, polyethylene naphthalate, polycarbonate, etc. Transparent glass can be, but is not limited to, alkali-free glass, soda-lime glass, phosphorus glass, or silicate glass.

For example, the microstructure 31c is made of, but is not limited to, optical clear adhesive (OCA), including silicone rubber, acrylic resin, unsaturated polyester, polyurethane, or epoxy resin.

Similar to the microstructure 31c, in order to maintain the transmittance of the metal mesh touch display device 1, the adhesive layer (for example the upper adhesive layer 31a and 33d, the lower adhesive layer 31d, 33a, and the adhesive layer 20 and the second adhesive layer 40 described below) is made of, but not limited to, optical clear adhesive (OCA), for example, silicone rubber, acrylic resin, unsaturated polyester, polyurethane, or epoxy resin.

More specifically, in the first embodiment of the present disclosure, the main material components of the upper adhesive layer 31a can be acrylic resin with a thickness of about 50 μm, for example 3M CEF1902; the main material components of the lower adhesive layer 31d can be acrylic resin with a thickness of about 100 μm, for example 3M CEF1904; the substrate layer 31b can be extruded polyester film with a thickness of 35-75 μm wherein the thickness of the substrate layer 31b in the first embodiment of the present disclosure is about 50 μm. The main material components of the microstructure 31c can be acrylic resin, wherein the convex parts of the wave form scattered on the specified surface of the microstructure 31c (surface that is vertical to the thickness direction of the microstructure layer 31 practically) and the distance between the neighboring convex parts is 6 μm-10 μm. The wave height (in the thickness direction, the vertical height between crest and trough) is 1.4-1.7 μm. Therefore, the ratio of depth to width (or height to width) of the microstructure 31c is about 0.1-0.3. Due to the fact that the quantity of microstructures 31c is large, the measure numbers are viewed as numbers derived through statistical methods (for example, average values) of general engineering. In summary, the total thickness of the microstructure layer 31 of the first embodiment of the present disclosure is about 0.2 mm. The total thickness of the microstructure layer 31 performs the effect of keeping the metal lines 52 apart from the light source in a predetermined distance.

In another embodiment, the cross section of the microstructure 31c is triangular, zigzag shape, sine shape, semi (oval) shape. In another embodiment, the distance between neighboring convex parts is 0.1 μm-50 μm. The distance between neighboring convex parts is adjustable. For example, the convex density is designed using the equation y=axⁿ originated from the centerline of the metal mesh touch display device 1 toward both sides, where y is the distance between a point on the metal mesh touch display device 1 to the centerline of the metal mesh touch display device 1; n is 1-3.5, and a is a constant associated with the dimension of the luminary area. The height of the wave shape (in the thickness direction, the vertical height between crest and trough) is 1-2 μm, or 1.4-1.7 μm. In an embodiment of changing conditions, the convex part is randomly set on the surface of the microstructure 31c. In another embodiment, the ratio of the depth to width (or height to width) of the microstructure 31c is in the range of about 0.1-1.5.

When the substrate layer 31b has a flat shape, and the interface between the microstructure 31c and the lower adhesive layer 31d has an un-even form, a material layer of the microstructure 31c is added on the substrate layer 31b; then the material layer of the microstructure 31c is processed through laser engraving, etching, coating, printing technologies to create the microstructure 31c. Next, the material of the lower adhesive layer 31d is applied on the microstructure 31c to fill the gaps on the un-even surface and to form the lower adhesive layer 31d at the same time.

To ensure that light, emitted from the display unit 10, scatters on the un-even interface, materials with different refractive index are used for forming the layers on both sides of the un-even interface. For example, the difference between the refractive indexes of the microstructure 31c and the lower adhesive layer 31d is greater than 0.01, 0.1, or 0.2. Specifically, a material with a smaller refractive index is selected for the lower adhesive layer 31d than that of the adjacent microstructure 31c. More specifically, the refractive index of the microstructure 31c is 1.5-1.7; the refractive index of the lower adhesive layer 31d is 1.4-1.6.

Preferably, in the first embodiment of the present disclosure, the refractive index of the microstructure 31c is about 1.5 at 532 nm wavelength; the refractive index of the lower adhesive layer 31d is about 1.47 at 532 nm wavelength.

Furthermore, in the first embodiment shown in FIG. 2, the microstructure layer 31 comprises the upper adhesive layer 31a, the substrate layer 31b, the microstructure 31c, and the lower adhesive layer 31d, disposed in a top-down order. However, the present disclosure is not limited to that and may shift the order of the microstructure layer of the embodiment, so long as the design has the astigmatism effect.

In the present disclosure, the outer surface of the microstructure layer 31 can further comprise an additional adhesive layer (for example, the first adhesive layer 20 and the second adhesive layer 40 described below) in order to adhere the microstructure layer 31 to other layers of the metal mesh touch display device 1 individually.

In the present disclosure, the outer surfaces of the microstructure 31c and/or the substrate layer 31b in the microstructure layer 31 are flat and adhesive, and the microstructure layer 31 can be adhered to other layers of the metal mesh touch display device 1 without having the lower adhesive layer 31d and/or the upper adhesive layer 31a. In other words, the microstructure 31c and/or substrate layer 31b both having a smooth flat outer surface and being adhesive can serve as the adhesive layer.

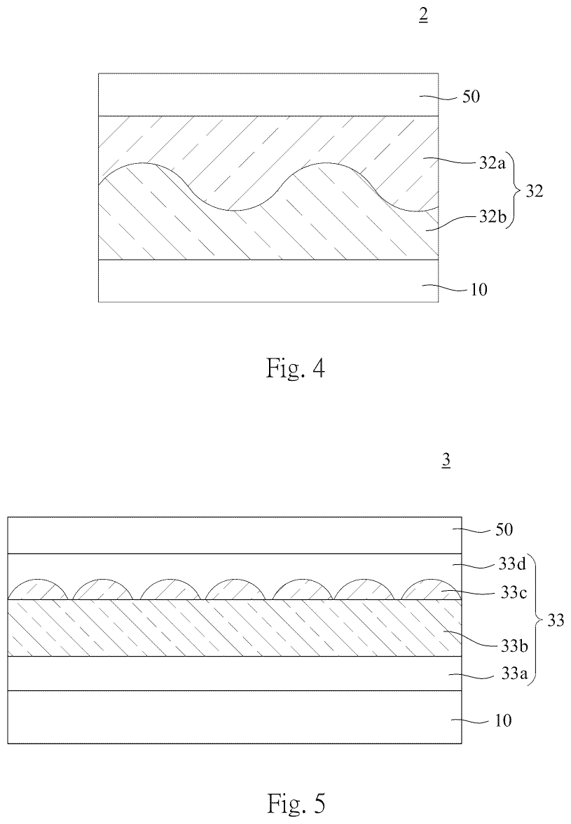

The second embodiment of the present disclosure has the same configuration as that of the first embodiment, except for microstructure layer 32. As shown in FIG. 4, in the metal mesh touch display device 2 of the second embodiment of the present disclosure, given the condition that the outer surfaces of the substrate layer 32a and the microstructure 32b of the microstructure layer 32 are flat and adhesive, the microstructure layer 32 can directly be adhered with other layers of the metal mesh touch display device 2 separately, such as the display unit 10 and the metal mesh touch unit 50 directly.

As shown in FIG. 4, the difference between the metal mesh touch display device 2 of the second embodiment and that of the first embodiment of the present disclosure is that the second embodiment does not include the upper adhesive layer 31a and the lower adhesive layer 31d.

Specifically, in the metal mesh touch display device 2 of the second embodiment of the present disclosure, the substrate layer 32a is disposed below the metal mesh touch unit 50; the microstructure 32b is disposed on the lower surface of the substrate layer 32a. The lower surface of the microstructure 32b has a flat shape whereas the upper surface of the microstructure 32b comprises a wave form, which is a combination of a plurality of convex parts and a plurality of concave parts. The distance of the adjacent convex parts is 10 μm-20 μm (please refer to the first embodiment for the convex part); the height of the convex part is about 10 μm. Therefore, the ratio between the depth to the width of the microstructure 32b (or, height to width) is about 0.5-1. Furthermore, the lower surface of the substrate layer 32a matches the shape of the upper surface of the microstructure 32b. The thicknesses of the microstructure 32b and the substrate layer 32a are about 0.1 mm. Therefore, the total thickness of the microstructure layer 32 of the second embodiment of the present disclosure is about 0.2 mm, which takes the metal lines 52 apart from the light source.

In the present disclosure, the surface of the substrate layer 32a that matches and is adhered to the un-even surface of the microstructure 32b can support and protect the microstructure 32b. Furthermore, since the substrate layer 32a and the microstructure 32b are adhered directly to the display unit 10 and the metal mesh touch unit 50, the substrate layer 32a and the microstructure 32b need to have excellent adhesion to prevent relative displacements between substrate layer 32a and the microstructure 32b caused by assembly stress.

Preferably, in the second embodiment of the present disclosure, the refractive index of the microstructure 32b can be set at 1.5-1.7 (for example, about 1.53, at 532 nm wavelength); the refractive index of the substrate layer 32a that is in contact with the microstructure 32b is 1.4-1.6 (for example, about 1.47, at 532 nm wavelength). Preferably, the refractive index of the substrate layer 32a is smaller than that of the adjacent microstructure 32b.

When the interface between the substrate layer 32a and the microstructure 32b is un-even; the substrate layer 32a is processed through laser engraving, etching, coating, printing technologies to create un-even surface; then, the microstructure materials are added on the substrate layer 32a in order to fill the gaps on the un-even surface and, at the same time, form the microstructure 32b.

As shown in FIG. 5, the differences between the metal mesh touch display device 3 of the third embodiment of the present disclosure and that of the first embodiment comprises: the microstructure layer 33 comprises a lower adhesive layer 33a, disposed on the display unit 10; a substrate layer 33b, disposed on the upper surface of the lower adhesive layer 33a and having a flat shape; a microstructure 33c, disposed on the upper surface of the substrate layer 33b and having a plurality of convex parts. The distance between neighboring convex parts is about 25.7 μm; the height of the convex part is about 6.2 μm. Therefore the ratio of depth to width (or height to width) of the microstructure 33c is about 0.24-0.3; and an upper adhesive layer 33d is disposed on the upper surfaces of both the microstructure 33c and the substrate layer 33b and on the metal mesh touch unit 50. The lower surface of the upper adhesive layer 33d has a shape that matched to the upper surfaces of both the microstructure 33c and the substrate layer 33b. The third embodiment of the present disclosure has the same configuration as that of the first embodiment, except the microstructure layer 33.

In the third embodiment of the present disclosure, the thicknesses of the lower adhesive layer 33a and the upper adhesive layer 33d can be 50±5 μm, for example, 45, 50, or 55 μm. The thickness of the substrate layer 33b can be 90±10 μm, for example, 80, 85, 90, 95, or 100 μm. The size of the convex part is from 10 μm to 50 μm. The ratio of the depth to width (or, height to width) of the microstructure 33c is about 0.1-0.5, or 0.2-0.4.

In the third embodiment of the present disclosure, the substrate layer 33b can be a crosslinkable-resin layer, for example thermosetting resin or ultra-violet curable (UV-curable) resin, specifically such as methacrylic resin, epoxy resin, or polysiloxane-based resin. The microstructure 33c can be formed on the substrate layer 33b through laser engraving, etching, coating, printing technologies to create an un-even surface; the microstructure 33c can be convex parts, concave parts, or the combination thereof.

In some embodiments of the present disclosure, the substrate layer 33b can have a shape that matches the microstructure 33c in order to fill the un-even portion on the microstructure 33c. Or, in other embodiments, the substrate layer 33b can have a flat shape; the microstructure 33c is disposed on partial or all the upper surface of the flat substrate layer 33b. Subsequently, other layers (for example, an adhesive layer or another substrate layer) are used to fill in the un-even shape of the microstructure 33c, so that the microstructure layer 33 can completely be adhered with other layers.

Preferably, in the third embodiment of the present disclosure, to further fine tune the astigmatism effect, the refractive index of the microstructure 33c can be set as 1.5-1.7; and the refractive index of the upper adhesive layer 33d that is in contact with the microstructure 33c can be set as 1.4-1.6. Preferably, the refractive index of the upper adhesive layer 33d that is in contact with the microstructure 33c can be set to be smaller than the refractive index of the microstructure 33c.

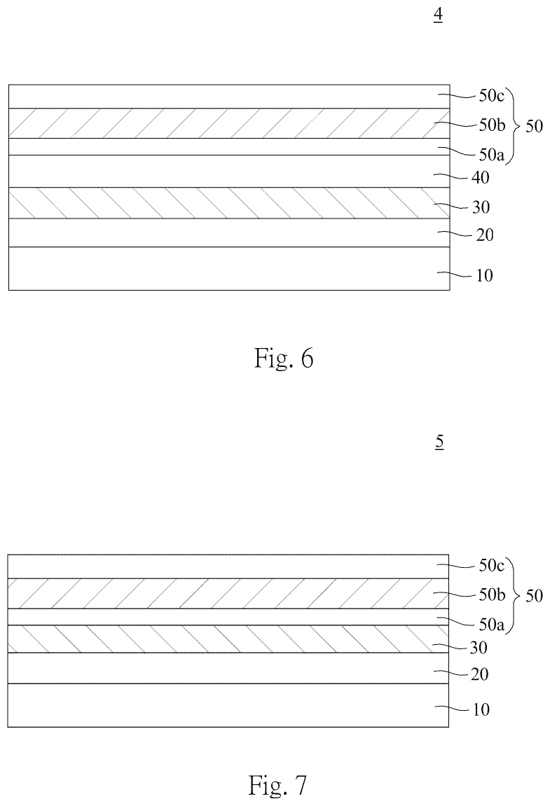

More specifically, please refer to FIG. 6 and FIG. 7. The metal mesh touch unit 50 of the present disclosure can comprise metal mesh electrodes 50a and 50c oriented along two directions (preferably, perpendicular directions); and a base layer 50b disposed therebetween.

Please refer to FIG. 6. The fourth embodiment of the present disclosure has the same configuration as that of the first embodiment, except the metal mesh touch unit 50.

The microstructure layer 30 is the same as any microstructure layer described previously, such as microstructure layer 31, 32, or 33.

The metal mesh touch unit 50 of the fourth embodiment comprises: a first metal mesh electrode 50a, oriented along a first direction (for example, X direction); a second metal mesh electrode 50c, oriented along a second direction (for example, Y direction); and a base layer 50b, located between the first metal mesh electrode 50a and the second metal mesh electrode 50c. The base layer 50b can be a substrate; the first metal mesh electrode 50a and the second metal mesh electrode 50c can form relatively opposite surfaces (for example, upper surface and lower surface) to the base layer 50b through laser engraving, etching, coating, printing technologies. In other embodiments, the base layer 50b is adhesive; the first metal mesh electrode 50a and the second metal mesh electrode 50c can be manufactured in advance and left on the separation film, and the first metal mesh electrode 50a and the second metal mesh electrode 50c are adhered onto opposite surfaces of the base layer 50b (for example, the upper surface and the lower surface) during the reposting process. Last, the separation film is removed.

The display unit 10 and the metal mesh touch unit 50 of the fourth embodiment of the present disclosure have the same configuration as the display unit 10 and the metal mesh touch unit 50 of any aforementioned embodiments, so that they will not be repeated again.

As with the aforementioned embodiments, in the fourth embodiment of the present disclosure, the distance of the surface of the display unit 10, especially the surface facing the metal mesh touch unit 50, and the metal mesh touch unit 50 is greater than 0.2 mm. Furthermore, the microstructure layer 30 can have any form described previously and will not be repeated again.

In the fourth embodiment of the present disclosure, the thickness of the first adhesive layer 20 can be 0.2 mm±0.05 mm, for example 0.15, 0.2, 0.25 mm; the thickness of the microstructure layer 30 can be 0.05±0.01 mm, for example, 0.04, 0.05, 0.06 mm; the thickness of the second adhesive layer 40 can be 0.05±0.01 mm, for example 0.04, 0.05, or 0.06 mm; the thickness of the base layer 50b of the metal mesh touch unit 50 can be 0.03-0.04 mm, for example polyester (PET) film of 0.038 mm.

Meanwhile, in the present disclosure, in order to maintain the transmittance of the metal mesh touch display device 4, except the metal mesh (the first metal mesh electrode 50a and the second metal mesh electrode 50c), the layers on the outer side of the display unit 10 (the side facing the users) are preferably made of transparent materials.

Thus, similar to the microstructure layer 30 and the first and second adhesive layers 20 and 40, the base layer 50b of the metal mesh touch unit 50 can be made of the aforementioned transparent plastic (such as PET). However, the present disclosure is not limited thereto.

In the fourth embodiment shown in FIG. 6, the outer surface of the microstructure layer 30 is installed with the first adhesive layer 20 and the second adhesive layer 40. However, if the outer surfaces of the top layer and/or the bottom layer of the microstructure layer 30 are adhesive, the first adhesive layer 20 and/or the second adhesive layer 40 can be omitted.

Please refer to FIG. 7. The difference between the metal mesh touch display device 5 of the fifth embodiment and that of the fourth embodiment of the present disclosure is that the outer surface of the top layer of the microstructure layer 30 facing the metal mesh touch unit 50 is adhesive, so that the second adhesive layer 40 is omitted.

Although not shown in the figure, the outer surface of the bottom layer of the microstructure layer 30 facing the display unit 10 is adhesive. Therefore, the first adhesive layer 20 is omitted.

In order to certify the improvement outcome of the gray grid of the metal mesh touch display devices 1, 2, 3, 4, 5 of the present disclosure, metal meshes with different line width are used. The improvement outcomes in term of gray grid levels of the metal mesh touch display devices 1, 2, 3, 4, 5 are presented in Table 1 through visual comparison and based on the embodiments (exemplary embodiments) of the present disclosure and the prior art (comparative embodiments).

The metal mesh touch display devices 1, 2, 3, 4, 5 of the present disclosure have a microstructure layer (thickness greater than 0.2 mm) disposed between the display unit 10 and the metal mesh touch unit 50; the metal mesh touch display device of the prior art only has a layer of smooth optical clear adhesive (OCA) (a thickness of 0.2 mm) that does not have mesh nodes. The aforementioned thickness is the distance between the upper surface of the display unit 10 and the metal mesh touch unit 50.

TABLE 1

| | | Line width = | Line width = |
|---|---|---|---|
| | Line width = | 4 μm | 4.5μm |
| | 3.5 μm | Area of | Area of |
| Metal | Area of nodes = 100 | nodes = 100 | nodes = 100 |
| Mesh | μm² | μm² | μm² |
| Comparative | Minor - moderate | Moderate | Moderate - Serious |
| Embodiment | | | |
| Exemplary | Minor | Minor | Moderate |
| Embodiment | | | |

The test result of the first exemplary embodiment of the present disclosure is listed in Table 1, with conditions of various metal meshes and line width, and in comparison with the comparative embodiment (only having an adhesive layer of 0.2 mm in thickness between the display unit 10 and the metal mesh touch unit 50). According to the present disclosure, the metal mesh touch display devices 1, 2, 3, 4, 5 further have an astigmatic microstructure with 0.2 mm in thickness in between the display unit 10 and the metal mesh touch unit 50, wherein the un-even surface of the microstructure provides the astigmatism effect, which is similar to the effect of enlarging the area of pixels. Therefore, the light emitted by the sub-pixels will not be easily blocked by metal lines. Meanwhile, the difference between the brightness between the shaded area and the non-shaded area is reduced. The distance between the surface of the display unit 10 and the metal mesh touch unit 50 is widened properly to be greater than 0.2 mm to reduce the blocking effect caused by metal meshes. The shaded area is reduced and, at the same time, the size of shadow generated by the metal mesh touch unit 50 is lessened. Therefore, the metal mesh touch display devices 1, 2, 3, 4, 5 provide significant improvements in gray grid effect relative to the prior art. It is worth mentioning that based on the experimental data in Table 1, having a metal line width of 4.5 μm/a node area of 100 μm², the coordination mechanism used in the present disclosure can effectively improve the gray grid problems. Therefore, by the same token, in products of larger line width and larger node area, the present disclosure can also deliver the same improvement on gray grid problems. In short, the coordination mechanism of the present disclosure can reduce the gray grid problems by having a metal line width of 5 μm/a node area of 200 μm². In other words, if using a metal mesh with a smaller line width and a smaller node area configuration (for example, line width of 2.5 μm/node area of 80 μm²), when the area is reduced, the gray grid problem will naturally improve. Together with the present disclosure, the gray grid improvement will be further improved.

One cause of the gray grid problem is that the light emitting pixels are relatively small. In the aforementioned embodiment, RGB sub-pixels of the display unit 10 are structured in the Pentile arrangement, wherein the G sub-pixels have the smallest area (about 840 μm²). Set the metal line width to 3 μm, and compare the optical features of G and B sub-pixels, gray grid problems are observed in G sub-pixels. However, after the present disclosure is implemented, gray grid problems in G sub-pixels are improved. In another embodiment, the G sub-pixels of the display unit 10 have the smallest area (about 484 μm²), and gray grid problems in G sub-pixels are also improved by the method of the present disclosed. In summary, with the aforementioned metal mesh dimensions and specification, when the smallest area of the sub-pixels of the display unit 10 is 400-900 μm², the gray grid problem can be improved by means of using the microstructure layer of the present disclosure.

### COMPONENT SYMBOL

1, 2, 3, 4, 5: metal mesh touch display device
10: display unit
10A: upper surface
20: first adhesive layer
30, 31, 32, 33: microstructure layer
31a, 33d: upper adhesive layer
31b, 32a, 33b: substrate layer
31c, 32b, 33c: microstructure
31d, 33a: lower adhesive layer
40: second adhesive layer
50: metal mesh touch unit
50a: first metal mesh
50b: base layer
50c: second metal mesh
51: lower surface
52: metal line
53: mesh node
100: light emitting spot
200: secondary light spot
a: region
d: line width

What is claimed is:

1. A metal mesh touch display device, comprising:
a metal mesh touch unit, having at least one of a metal line width greater than 2.5 μm or a mesh node having an area that is greater than 80 μm²;
a display unit, having a plurality of light emitting pixels, wherein a light emitting pixel density of the display unit is greater than 150 ppi; and
a microstructure layer, located between the display unit and the metal mesh touch unit, and having a substrate layer and a microstructure;
wherein a distance between a surface of the display unit and the metal mesh touch unit is greater than 0.2 mm.

2. The metal mesh touch display device as claimed in claim 1, wherein:
at least one surface of the microstructure has a plurality of convex parts, a plurality of concave parts, or a combination thereof, to form an astigmatic structure; or
the microstructure has a plurality of convex parts, a plurality of concave parts, or a combination thereof, to form an astigmatic structure.

3. The metal mesh touch display device as claimed in claim 1, wherein at least one of the metal line width is greater than 3.5 μm or the area of the mesh node is greater than 100 μm².

4. The metal mesh touch display device as claimed in claim 1, wherein at least one of the metal line width is between 3.5-5 μm or the area of the mesh node is greater than 80-200 μm².

5. The metal mesh touch display device as claimed in claim 1, wherein the distance between the surface of the display unit and the metal mesh touch unit is between 0.2-1.0 mm.

6. The metal mesh touch display device as claimed in claim 1, wherein the light emitting pixel density of the display unit is 150-400 ppi.

7. The metal mesh touch display device as claimed in claim 1, wherein:
the microstructure layer further comprises an upper adhesive layer and a lower adhesive layer;
the upper adhesive layer is disposed below the metal mesh touch unit;
the substrate layer is disposed on a lower surface of the upper adhesive layer and has a flat shape;
the microstructure is disposed on a lower surface of the substrate layer and a lower surface of the microstructure has a plurality of convex parts, a plurality of concave parts, or a combination thereof to form an astigmatic structure; and
the lower adhesive layer is disposed between the lower surface of the microstructure and the display unit, wherein an upper surface of the lower adhesive layer has a shape that matches and fits to the lower surface of the microstructure.

8. The metal mesh touch display device as claimed in claim 7, wherein a distance between neighboring convex parts of the plurality of convex pars is 0.1-50 μm.

9. The metal mesh touch display device as claimed in claim 7, wherein a ratio of depth to width of the microstructure is about 0.1-1.5.

10. The metal mesh touch display device as claimed in claim 1, wherein:
the microstructure is disposed on a lower surface of the substrate layer;
an upper surface of the microstructure has a plurality of convex parts, a plurality of concave parts, or a combination thereof, to form an astigmatic structure; and
the lower surface of the substrate layer has a shape that matches and fits to the upper surface of the microstructure.

11. The metal mesh touch display device as claimed in claim 10, wherein a distance between neighboring convex parts of the plurality of convex parts is 0.1-50 μm.

12. The metal mesh touch display device as claimed in claim 10, wherein a ratio of depth to width of the microstructure is about 0.1-1.

13. The metal mesh touch display device as claimed in claim 1, wherein
the microstructure layer further comprises a lower adhesive layer and an upper adhesive layer;
the lower adhesive layer is disposed on the display unit;
the substrate layer is disposed on an upper surface of the lower adhesive layer and has a flat shape;
the microstructure is disposed on an upper surface of the substrate layer and is composed of a plurality of convex parts; and
the upper adhesive layer is disposed between both an upper surface of the microstructure and the upper surface of the substrate layer, and the metal mesh touch unit; a lower surface of the upper adhesive layer has a shape that matches and fits to both the upper surface of the microstructure and the upper surface of the substrate layer.

14. The metal mesh touch display device as claimed in claim 13, wherein a distance between neighboring convex parts of the plurality of convex parts is 0.1-50 μm.

15. The metal mesh touch display device as claimed in claim 13, wherein a ratio of depth to width of the microstructure is about 0.1-1.5.

16. The metal mesh touch display device as claimed in claim 1, wherein
the metal mesh touch unit comprises:
a first metal mesh electrode, oriented along a first direction;
a second metal mesh electrode, oriented along a second direction; and
a base layer, located between the first metal mesh electrode and the second metal mesh electrode.

17. A metal mesh touch display device comprising
a metal mesh touch unit, having at least one of a metal line width greater than 2.5 μm or a mesh node having an area that is greater than 80 μm²;
a display unit, having a plurality of light emitting pixels, wherein an area of a smallest light emitting pixel of the plurality of light emitting pixels of the display unit is 400-900 μm²; and
a microstructure layer located between the display unit and the metal mesh touch unit and having a substrate layer and a microstructure,
wherein a distance between a surface of the display unit and the metal mesh touch unit is greater than 0.2 mm.

18. The metal mesh touch display device as claimed in claim 17, wherein
the microstructure has a plurality of convex parts, a plurality of concave parts, or a combination thereof to form an astigmatic structure.

19. The metal mesh touch display device as claimed in claim 18, wherein a distance between neighboring convex parts of the plurality of convex parts is 0.1-50 μm.

20. The metal mesh touch display device as claimed in claim 17, wherein a ratio of depth to width of the microstructure is about 0.1-1.5.
